(19) United States
(12) Patent Application Publication
(10) Pub. No.: US 2010/0131701 A1
(43) Pub. Date: May 27, 2010

(54) NONVOLATILE MEMORY DEVICE WITH PREPARATION/STRESS SEQUENCE CONTROL

(75) Inventor: Daisuke FUJIWARA, Yokohama (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Suwon-si (KR)

(21) Appl. No.: 12/608,387

(22) Filed: Oct. 29, 2009

(30) Foreign Application Priority Data
Nov. 25, 2008 (JP) 2008-300204
Jul. 28, 2009 (KR) 10-2009-0068975

(51) Int. Cl. G06F 12/00; G06F 12/02

(52) U.S. Cl. 711/103; 711/E12.001; 711/E12.008

(57) ABSTRACT

Provided is a nonvolatile memory device which includes a command buffer configured to receive and store a sequence of first and second commands, a memory including an array of nonvolatile memory cells, and an operation controller configured to control the execution of first and second operations in the memory as respectively defined by the first and second commands, wherein each one of the first and second operations comprises a preparation sequence followed by a stress sequence, and execution of the preparation sequence for the second operation is parallel with the stress sequence of the first operation.

### CROSS-REFERENCE TO RELATED APPLICATIONS

This U.S. non-provisional patent application claims priority under 35 U.S.C. §119 to Korean Patent Application No. 10-2009-0068975 filed on Jul. 28, 2009 and Japanese Patent Application No. 2008-300204 filed on Nov. 25, 2008, the collective subject matter of which is hereby incorporated by reference.

### BACKGROUND

The present inventive concept relates to nonvolatile memory devices and more particularly to nonvolatile memory devices having a sequence of operations characterized by reduced operating time enabled by controlled preparation of the sequence of operations.

Each operation (e.g., write, erase and read) executed in a nonvolatile memory device includes a preparation sequence and a stress sequence. Each preparation sequence is characterized by little or no voltage stress caused, for example, by a sector load, sector check, and/or data load to a memory cell. The preparation sequence is a period during which circuits are set up and stability is checked prior to following sequence(s). Each stress sequence is characterized by a voltage boost, the application of voltage(s) to a memory cell and/or voltage drop occurring as part of (e.g.,) a write operation, an erase operation and/or a read operation. Operation including these sequences is typically performed under the control of a memory device controller generating various control signals applied within the constituent memory device.

FIG. 5A is a block diagram illustrating a conventional memory device performing a sequence of operations under the control of an operation controller. FIG. 5B is a conceptual block diagram illustrating a series of conventional sequences executed in relation to multiple operations.

In FIG. 5A, an operation controller 1 comprises a preparation state unit 12 and a stress state unit 14. The preparation state unit 12 receives command(s) from a command generation unit 30. Following execution of a preparation sequence in response to the received command, a stress sequence is initiated by the stress state unit 14. Various control signal(s) are communicated from the operation controller 1 to a memory 60 in order to successfully execute a stress operation.

FIG. 5B illustrates the series of two (first and second) operations executed in relation to the memory 60 by operation controller 1. Successive preparation and sequences are serially generated in the illustrated example. Each stress sequence begins only after completion of a corresponding preparation sequence so that associated circuitry will function properly during execution of the stress sequence. However, the efficiency of the memory device is limited by this serial execution of operations. Nonetheless, this loss of efficiency has been deemed tolerable in view of the beneficial effects of first performing a preparation sequence before executing a stress sequence.

The many different operations that may be executed in contemporary memory devices include the so-called “write buffer operation” (or write buffer program). During a write buffer operation, a large amount of data is first loaded to a buffer and then continuously written from the buffer. Thus, write buffer operations are designed to transfer a large amount of data within a memory device, but sometimes this transfer process seeks to move more data than existing data pathways (i.e., bandwidth) can handle. When this situation arises the initial “load operation” takes a long time and overall efficiency in the operation of the memory device suffers.

Japan Patent Publication No. 2008-204623 discloses an approach to write buffer operations that uses first and second buffer memories. The first and second buffer memories both receive data stored in a plurality of memory blocks, and are, effectively, disposed in parallel with the plurality of memory blocks. Data stored in the second buffer memory is output via an input/output (I/O) port while data stored in the first buffer memory may be written in any one of the plurality of memory blocks. This configuration increases the speed of certain write operations, like a write buffer operation, in storing data to nonvolatile memory devices.

### SUMMARY

The inventive concept provides a nonvolatile memory device that controls execution of preparation and stress sequences in an operation, such that some portion of the preparation and stress sequences are executed in parallel, thereby reducing overall operation time for the memory device.

In one embodiment, the inventive concept provides a nonvolatile memory device, including a command buffer configured to receive and store a sequence of first and second commands, a memory comprising an array of nonvolatile memory cells, and an operation controller configured to control the execution of first and second operations in the memory as respectively defined by the first and second commands, wherein each one of the first and second operations comprises a preparation sequence followed by a stress sequence, and execution of the preparation sequence for the second operation is parallel with the stress sequence of the first operation.

In one related aspect, the operation controller comprises; a preparation state unit configured to sequentially receive the first and second commands, respectively execute preparation sequences of the first and second operations in response to the first and second commands, and activate a preparation state termination signal following execution of each preparation state, and a stress state unit configured to execute a stress sequence associated with the second operation only in response to activation of a command indication signal indicating the second command is a current command, activation of a preparation state termination signal indicating execution of a preparation sequence for the second command, and a succeeding command OK signal indicating execution of the stress sequence associated with the first operation.

In another related aspect, the operation controller may further comprise; a logic unit configured to receive the command indication signal, the preparation state termination signal, and the succeeding command OK signal, and activating a stress operation signal upon concurrent activation of the command indication signal, the preparation state termination signal, and the succeeding command OK signal, wherein execution of a stress sequence by the stress state unit is enabled by an activated stress operation signal.

In another related aspect, the stress state unit may further be configured to activate the succeeding command OK signal upon execution of a corresponding stress sequence.

In yet another aspect, the execution of the stress sequence for the second operation may be delayed by a wait period following execution of the preparation sequence for the second operation until the stress sequence for the first operation is completed.

### BRIEF DESCRIPTION OF THE DRAWINGS

The accompanying drawings show certain embodiments of the inventive concept. In the figures:

FIG. 1A is a block diagram illustrating a nonvolatile memory device according to an embodiment of the inventive concept;

FIG. 1B is a diagram illustrating multiple operations executed in a nonvolatile memory device according to an embodiment of the inventive concept;

FIG. 2 is a command array diagram illustrating a storage state for a series of commands in the command buffer of FIG. 1A;

FIG. 3 is a block diagram further illustrating the operation controller of FIG. 1A;

FIG. 4 is an operation sequence diagram illustrating an erasion operation and a write buffer operation according to an embodiment of the inventive concept;

FIG. 5A is a diagram illustrating a conventional nonvolatile memory device;

FIG. 5B is a block diagram illustrating conventional serial execution of operations, each including serially executed sequences;

FIG. 6 is a block diagram illustrating a memory card susceptible to incorporation of a nonvolatile memory device according to an embodiment of the inventive concept;

FIG. 7 is a block diagram illustrating a moviNAND susceptible to the incorporation of a nonvolatile memory device according to an embodiment of the inventive concept;

FIG. 8 is a block diagram illustrating a solid state drive (SSD) susceptible to the incorporation of a nonvolatile memory device according to an embodiment of the inventive concept;

FIG. 9 is a block diagram illustrating a server system incorporating a SSD like the one illustrated in FIG. 8;

FIG. 10 is a block diagram illustrating a computational system susceptible to the incorporation of a nonvolatile memory device according to an embodiment of the inventive concept; and

FIG. 11 is a block diagram illustrating a general electronic device susceptible to the incorporation of a nonvolatile memory device according to an embodiment of the inventive concept.

### DESCRIPTION OF EMBODIMENTS

Embodiments of the inventive concept will now be described in some additional detail with reference to the accompanying drawings. The inventive concept may, however, be embodied in different forms and should not be construed as limited to only the illustrated embodiments. Rather, these embodiments are presented as teaching examples.

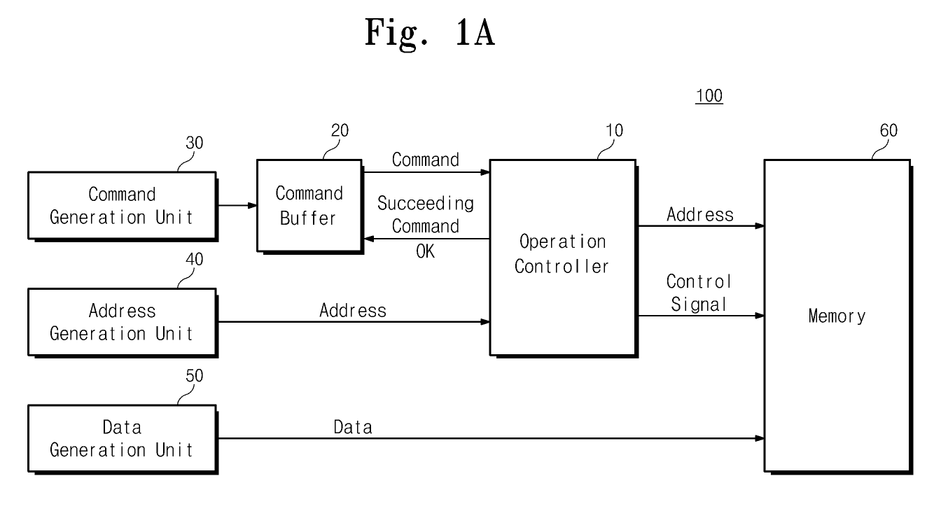

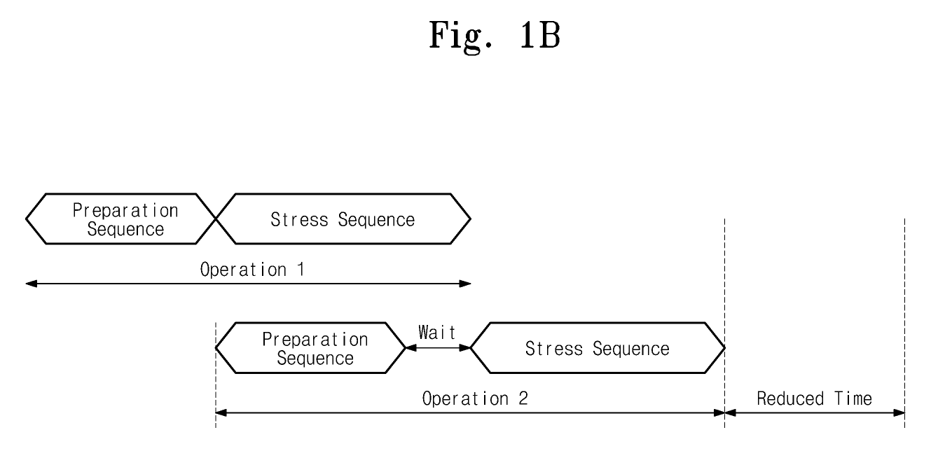

FIG. 1A is a block diagram illustrating a nonvolatile memory device according to an embodiment of the inventive concept. FIG. 1B is a related conceptual diagram illustrating the execution of successive operations in a nonvolatile memory device according to an embodiment of the inventive concept.

Referring to FIG. 1A, a nonvolatile memory device 100 comprises a command generation unit 30, a command buffer 20, an operation controller 10, an address generation unit 40, a data generation unit 50, and a memory 60. As is conventionally understood, the command generation unit 30 generates various commands causing execution of a plurality of operations within the memory device 100, such as write (or program) operations, erase operations, and/or read operations. The command buffer 20 stores the commands generated by the command generation unit 30. The operation controller 10 controls the overall execution of operations in response to commands provided by the command buffer 20 in conjunction with the address generation unit 40 which generates an address associated with an ongoing operation (i.e., “a current operation”). That is, the address generated by address generation unit 40 and applied to operation controller 10 identifies certain memory cell(s) indicated or implicated by one or more commands defining the current operation. In similar vein and as is conventionally understood, the data generation unit 50 provides data related to a current operation to the memory 60.

Interoperation between the command buffer 20 and operation controller 10 is controlled by providing commands stored in command buffer 20 to the operation controller 10, which in turn returns a succeeding command OK confirmation signal following execution of the command.

During operations, the operation controller 10 controls various circuitry associated with a memory cell array in memory 60 using an address and one or more control signal(s).

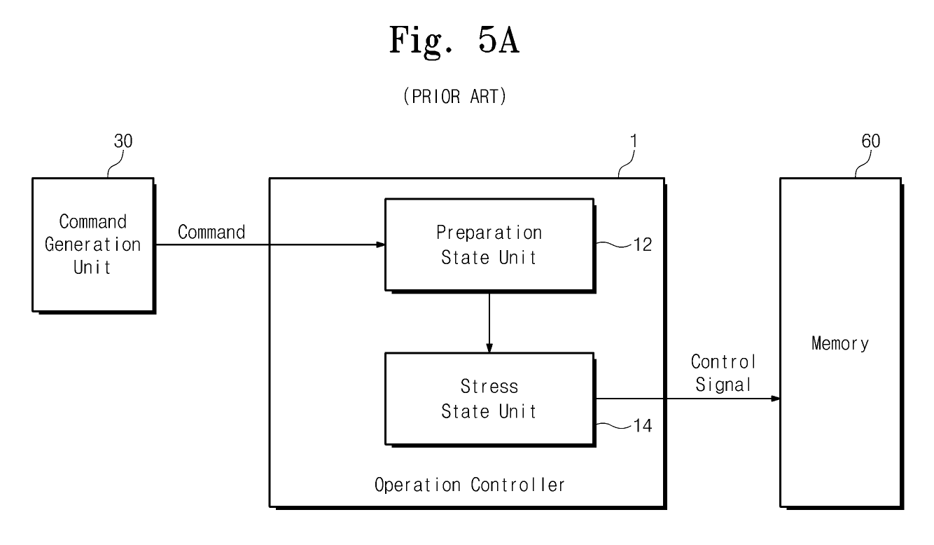

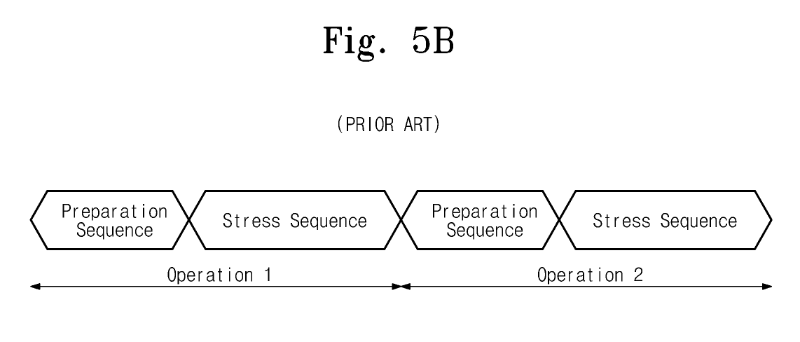

FIG. 1B illustrates execution of two successive operations (first and second operations) in relation to the memory device 100 of FIG. 1 by operation controller 10 in response to commands received from the command buffer 20. As will be explained in some additional detail hereafter, the partially overlapping (i.e., “parallel”) execution of the first and second operations results in some reduced period of time for complete execution, as compared with the fully serial execution of operations shown in FIG. 5B.

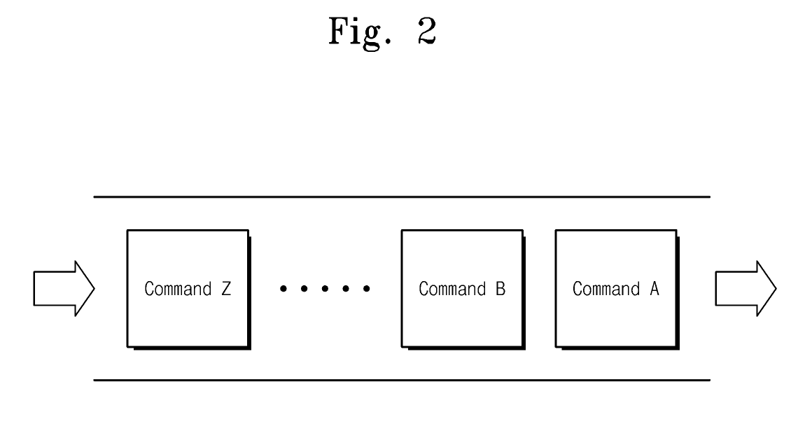

Referring to the conceptual illustration of FIG. 2, the command buffer 20 operates in certain embodiments of the inventive concept as a first-in, first-out (FIFO) buffer. Thus, as received in sequence from command generation unit 30, a first received command A is first provided to operation controller 10, then a second command B is provided, down though an Nth received, buffered and provided command Z.

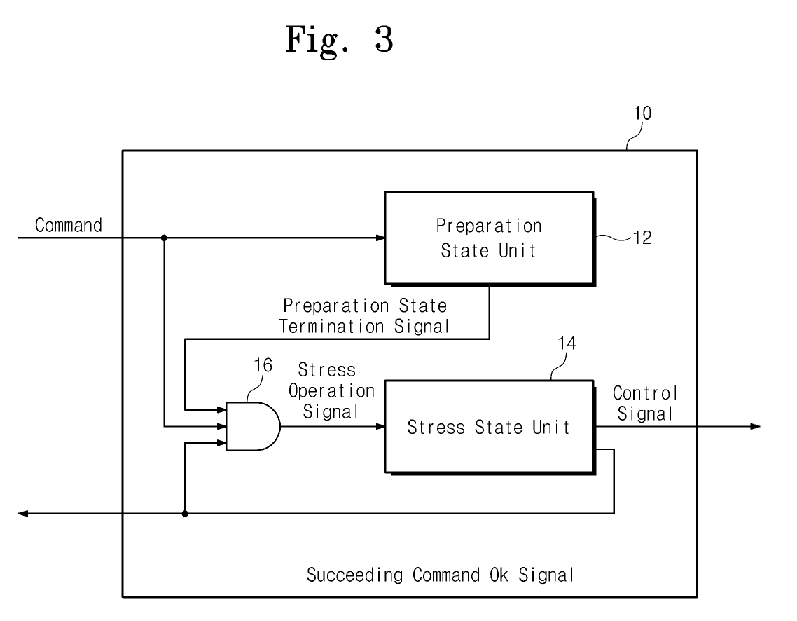

FIG. 3 is a block diagram further illustrating the operation controller 10 of FIG. 1A according to an embodiment of the inventive concept.

Referring to FIG. 3, the internal operation controller 10 comprises a preparation state unit 12 executing a preparation sequence, a stress state unit 14 executing a stress sequence, and a logic unit 16 controlling the flow and timing of sequence execution within operation controller 10.

Referring collectively to FIGS. 1 through 3, the preparation state unit 12 within operation controller 10 waits to execute the stress sequence of the second operation (i.e., the second stress sequence) until execution of the stress sequence of the first operation (i.e., the first stress sequence) as shown in FIG. 1B and in response to associated command signal(s) received from command buffer 20. This flow of operations is controlled as follows.

First, a preparation state termination signal is generated in an activated state by the preparation state unit 12 following completion of each preparation sequence. The state termination signal is applied as one input to the logic unit 16 (e.g., an AND gate) along with the “current” (i.e., activated) command indication. A succeeding command OK signal is generated by the stress state unit 14 and is also provided as an input to logic unit 16.

The logic unit 16 provides a stress operation signal to the stress state unit 14. The stress operation signal becomes activated when the command indication, the preparation state termination signal, and the succeeding command OK signal are all activated (i.e., the ANDed combination is activated). These three logic unit 16 inputs are all related to a current command. That is, the command indication indicates an active current command (e.g., command B in FIG. 3) being executed by the operation controller 10. The preparation state termination signal indicates completion of the preparation sequence for the current command. And the succeeding command OK signal indicates the successful execution (both preparation and stress sequence) for an immediately preceding command (e.g., command A of FIG. 3).

The stress state unit 14 outputs a succeeding command OK signal to the logic unit 16 and command buffer 20 following execution of each stress sequence. Additionally, the stress state unit 14 outputs the one or more control signal(s) to the memory 60 in response to execution of a stress sequence.

The command buffer 20 may provide the command indication signal to the operation controller 10 with each provision of a current command, only after first receiving a succeeding command OK signal for the immediately preceding command.

The preparation state unit 12 executes each preparation sequence of an operation associated with a current command upon receiving the command indication signal (i.e., upon receiving the current command from the command buffer following receipt of a succeeding command OK signal). Upon execution of each preparation sequence, the preparation state unit provides an activated preparation state termination signal to logic unit 16.

The logic unit 16 is only enabled to provide an activated stress operation signal to the stress state unit 14 upon concurrent activation of the command indication signal, the preparation state termination signal, and the succeeding command OK signal.

Thus, the stress state unit 14 provides the succeeding command OK signal to the logic unit 16 and command buffer 20 in response to a stress operation signal and successful execution of a current command, which upon successful execution of its preparation sequence and stress sequence becomes the preceding command in relation to the further operation of the command buffer 20 and stress unit 14.

In the series of operations illustrated in FIG. 1B, a wait period is generated between completion of the second preparation sequence and initiation of the second stress sequence. This wait period ensures that resources in the memory device 100 utilized by the first stress operation are freed up before execution of the second stress sequence, if execution of the first stress sequence takes longer than the second preparation sequence. In this manner, the stress state unit 14 controls the provision of the one or more control signal(s) to memory 60 in relation to the execution of immediately preceding operation, yet allows some parallel execution of the two succeeding operations in relation to a second occurring preparation sequence and a first occurring stress sequence.

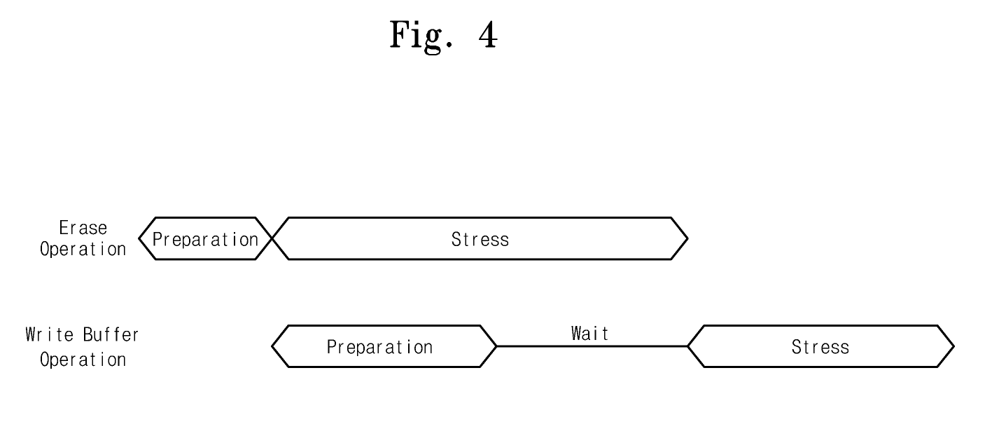

FIG. 4 more specifically illustrates the execution of an erase operation and a write buffer operation according to an embodiment of the inventive concept.

Referring to FIG. 4, during the preparation sequence of the erase operation, the memory 60 performs a sector load followed by a sector check. Subsequently, during the execution of the stress sequence for the erase operation, the preparation sequence of the write buffer operation begins. The preparation sequence for the write buffer operation may actually be completed before the stress sequence of the erase operation is completed. Hence, a wait period is entered following completion of the preparation time of the write buffer operation until such time as the stress sequence for the erase operation is completed.

For example, the preparation section of the write buffer operation may include a data load, as well as a sector load and a sector check. The time required to execute the write buffer program including the data load varies with the amount of data and the capacity of the data buffer receiving the data load. Assuming a load data of 512 words and conventionally common data buffer size, the write buffer operation may run about 40 to 50 μs. Under these assumptions, because at least the data load of the write buffer operation is executed in parallel during the stress sequence of the erase operation, the cumulative time required for execution of the erase operation and write buffer operation may be reduced by several tens of microseconds. This operating speed efficiency for the nonvolatile memory device only increases with continued parallel execution (i.e., at least partially overlapping) of temporally adjacent operations.

Thus, nonvolatile memory devices according to embodiments of the inventive concept include a command buffer that allows a second occurring preparation sequence defined by a second command (or second collection of commands) to be executed in parallel with a first occurring stress sequence defined by a first command (or first collection of commands). In this manner, the overall operation of nonvolatile memory devices according to embodiments of the inventive concept may be reduced while continuously applying commands to be executed.

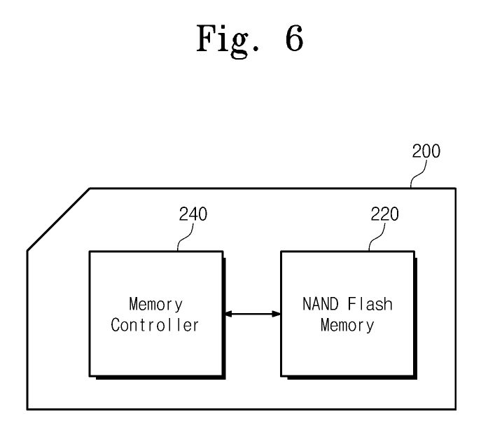

FIG. 6 is a block diagram illustrating a memory card susceptible to incorporation of a nonvolatile memory device according to an embodiment of the inventive concept. Referring to FIG. 6, a memory card 200 comprises a NAND flash memory device 220, and a memory controller 240 configured to control the NAND flash memory device 200. The NAND flash memory device 220 may be implemented and operated like the nonvolatile memory device 100 of FIG. 1A.

The memory controller 240 may be conventionally connected to a host device in order to provide an interface to the NAND flash memory device 220. In response to various data storage and retrieval requests from the host, the memory controller 240 will access the NAND flash memory device 220. Thus, memory controller 240 may incorporate the functionality of the command generation unit 30, command buffer 20, operation controller 10, address generation unit 40, and/or data generation unit 50 described above in relation to FIG. 1A.

The memory controller 240 may drive a firmware controlling the NAND flash memory device 220. As is conventionally understood, the memory controller 220 may include Random Access Memory (RAM), processing unit(s), and various interfaces. For example, a host interface may connect the host to the memory card according to a known protocol (e.g., as a Multimedia Card or MMC) in order to exchange data between the host and memory controller 240. That is, the memory card 200 may implement a MMC, a Security Digital (SD) card, a miniSD card, a Memory Stick (MS) card, a SmartMedia card, or a TransFlash card.

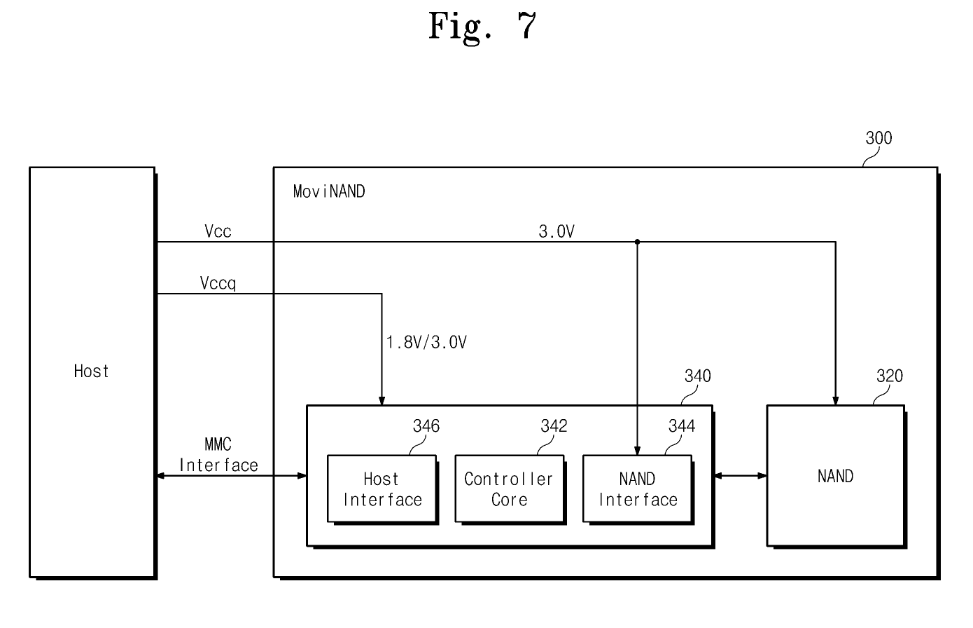

FIG. 7 is a block diagram illustrating a moviNAND susceptible to incorporation of a nonvolatile memory device according to an embodiment of the inventive concept. Referring to FIG. 7, a moviNAND 300 comprises a NAND flash memory device 320 and a controller 340.

The NAND flash memory device 320 may be implemented by stacking a plurality of single-item NAND flash memories on a Fine-pitch Ball Grid Array (FBGA). Each one of the plurality of single-item NAND flash memories may be implemented as the nonvolatile memory device 100 of FIG. 1A. The NAND flash memory device 320 may include multi level or single level memory cells.

The controller 340 includes a controller core 342, a NAND interface 344, and a host interface 346. The controller core 342 controls the overall operation of the moviNAND 300. The NAND interface 344 interfaces the NAND flash memory device 320 and the controller 340. The host interface 246 performs MMC interface between the controller 340 and the host.

The moviNAND 300 receives power supply voltages Vcc and Vccq from the host. Herein, the power supply voltage Vcc (for example, 3V) is supplied to the NAND flash memory device 320 and the NAND interface 244, and the power supply voltage Vccq (for example, 1.8V or 3V) is supplied to the controller 340.

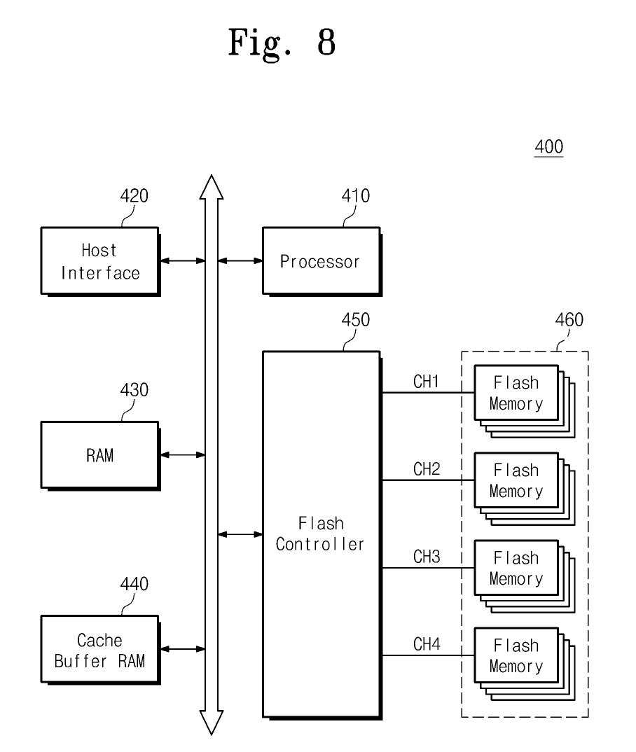

An embodiment of the inventive concept may be applied to a Solid State Drive (SSD). For example, FIG. 8 is a block diagram illustrating a SSD susceptible to incorporation of a nonvolatile memory device according to an embodiment of the inventive concept.

Referring to FIG. 8, a SSD 400 comprises a processor 410, a host interface 420, a RAM 430, a cache buffer RAM 440, a flash controller 450, and a plurality of flash memory devices 460. Each one of the plurality of flash memory devices 460 may be implemented as the nonvolatile memory device 100 of FIG. 1A.

The host interface 420 exchanges data with the host according to the control of the processor 410. The host interface 420 fetches a command and an address from the host to transfer the fetched command and address to the processor 410 through a Central Processing Unit (CPU) bus. Herein, the host interface 420 may be any one of a SATA interface, a PATA interface and an External SATA (ESATA) interface.

Data, which are inputted from the host through the host interface 420 or should be transmitted to the host, may be transferred through the cache buffer RAM 440 without passing through the CPU bus, according to the control of the processor 410.

The RAM 430 may be used to temporarily store data necessary for the operation of the SSD 400. Such a RAM 430 is a nonvolatile memory device, and may be Dynamic RAM (DRAM) or Static RAM (SRAM).

The cache buffer RAM 440 may temporarily store movement data between the host and the flash memory devices 460. Moreover, the cache buffer RAM 440 may be used to store a program to be operated by the processor 410. The cache buffer RAM 440 may be regarded as a sort of buffer memory, and may be implemented as a SRAM.

The flash controller 450 exchanges data with the flash memory devices 460 that are used as memory devices. The flash controller 450 may support a NAND flash memory, a One-NAND flash memory, a multi-level flash memory and a single-level flash memory.

The processor 410 and the flash controller 450 may be implemented as one ARM processor.

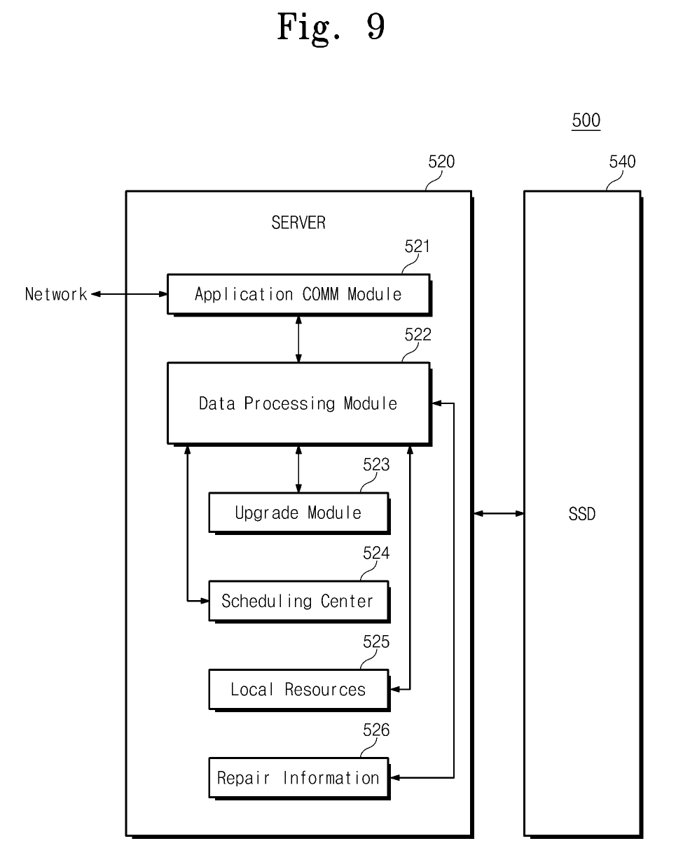

FIG. 9 is a block diagram illustrating an embodiment of a server system incorporating a SSD like the one shown in FIG. 8. Referring to FIG. 9, a sever system 500 comprises a server 520 and an SSD 540 storing data for the server 520. The SSD 540 may include the same elements as those of the SSD 400 in FIG. 8.

The server 520 may further include an application communication module 521, a data processing module 522, an upgrade module 523, a scheduling center 524, a local resource module 525, and a repair information module 527.

The application communication module 521 may communicate with a computing system that is connected to the server 520 over a network, or may allow the server 520 to communicate with the SSD 540. The application communication module 521 transmits data or information that is provided through a user interface, to the data processing module 522.

The data processing module 522 is linked to the local resource module 525. Herein, the local resource module 525 may provide the list of repair shops/dealers/technical information to a user on the basis of data or information that is inputted to the server 520.

The upgrade module 523 interfaces the data processing module 522. The upgrade module 523 upgrades appliances with firmware information, reset code information, diagnosis system upgrade information or other information on the basis of data or information that is transmitted from the SSD 540.

The scheduling center 524 allows real-time options to a user on the basis of data or information that is inputted to the server 520.

The repair information module 526 interfaces the data processing module 522. The repair information module 526 is used to provide repair-related information (for example, audio, video, or document files) to a user. The data processing module 522 packages relevant information on the basis of information that is transferred from the SSD 540. Subsequently, such information is transmitted to the SSD 540 or is displayed to the user.

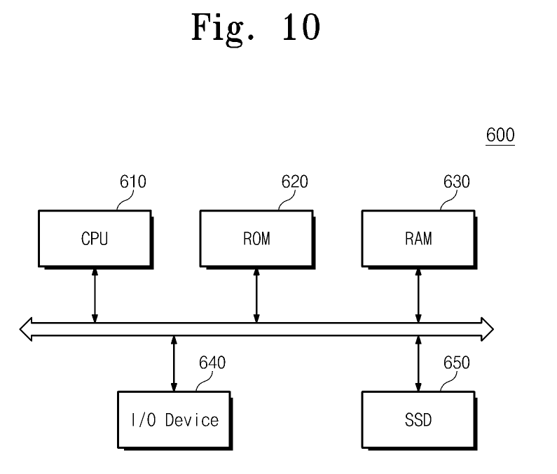

FIG. 10 is a block diagram illustrating a computational system susceptible to incorporation of a nonvolatile memory device according to an embodiment of the inventive concept. Referring to FIG. 10, a computational system 600 comprises a CPU 610, a Read Only Memory (ROM) 620, a RAM 630, an input/output (I/O) device 640, and a SSD 650.

The CPU 610 is connected to a system bus. The ROM 620 stores data necessary for the driving of the computing system 600. Such data may be a start command sequence, or a basic input/output operation system (for example, BIOS) sequence. The RAM 630 temporarily stores data that are generated when the CPU 610 is executed.

The I/O device 640, for example, may include a keyboard, a pointing device (for example, a mouse), a monitor and a modem that are connected to the system bus through an I/O device interface.

The SSD 650 is a readable memory device and may be implemented like the SSD 400 in FIG. 8.

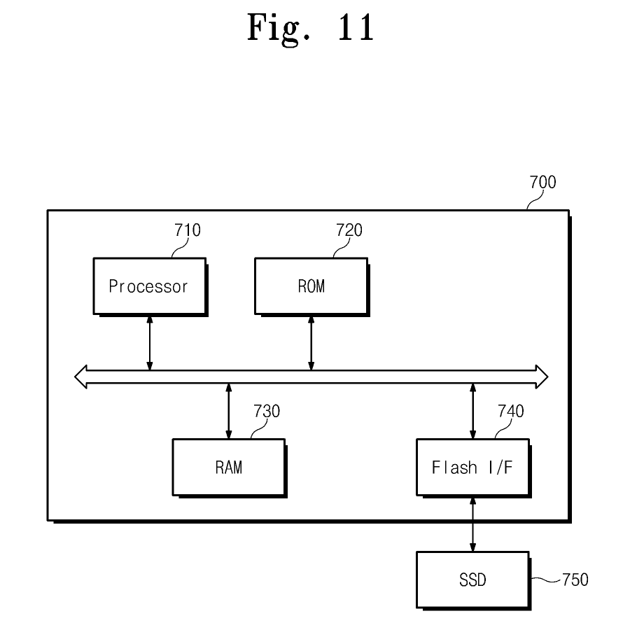

FIG. 11 is a block diagram illustrating a general electronic device susceptible to incorporation of a nonvolatile memory device according to an embodiment of the inventive concept. Referring to FIG. 11, an electronic device 700 comprises a processor 710, a ROM 720, a RAM 720, a flash interface 740, and an SSD 750.

The processor 710 accesses the RAM 730 for executing a firmware code or an arbitrary code. Moreover, the processor 710 accesses the ROM 720 for executing fixed command sequences such as a start command sequence or basic I/O operation system sequences. The flash interface 740 performs interface between the electronic device 700 and the SSD 750.

The SSD 750 may be attachable to and detachable from the electronic device 700. The SSD 750 may be implemented like the SSD 400 of FIG. 8.

The electronic device 700 may be a cellular phone, a Personal Digital Assistant (PDA), a digital camera, a camcorder, a portable audio replay device (for example, MP3), and a PMP.

The memory system or a memory device according to embodiments of the inventive concept may be mounted with various types of packages. For example, the memory system or the memory device according to embodiments of the inventive concept may be mounted with packages such as Package on Package (PoP), Ball Grid Arrays (BGAs), Chip Scale Packages (CSPs), Plastic Leaded Chip Carrier (PLCC), Plastic Dual In-Line Package (PDIP), Die In Waffle Pack (DIWP), Die In Wafer Form (DIWF), Chip On Board (COB), Ceramic Dual In-Line Package (CERDIP), Plastic Metric Quad Flat Pack (MQFP), Thin Quad Flatpack (TQFP), Small Outline (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP) and Wafer-Level Processed Stack Package (WSP).

According to embodiments of the inventive concept, nonvolatile memory devices control the parallel execution of a second occurring preparation sequence associated with a second operation with a first occurring stress sequence associated with a first operation. Thus approach enables the combined execution time for the first and second operations to be reduced.

The above-disclosed subject matter is to be considered illustrative, and not restrictive, and the appended claims are intended to cover all such modifications, enhancements, and other embodiments, which fall within the scope of the inventive concept. Thus, to the maximum extent allowed by law, the scope of the present inventive concept is to be determined by the broadest permissible interpretation of the following claims and their equivalents, and shall not be restricted or limited by the foregoing detailed description.

What is claimed is:

1. A nonvolatile memory device, comprising:
a command buffer configured to receive and store a sequence of first and second commands;
a memory comprising an array of nonvolatile memory cells; and
an operation controller configured to control the execution of first and second operations in the memory as respectively defined by the first and second commands, wherein each one of the first and second operations comprises a preparation sequence followed by a stress sequence, and execution of the preparation sequence for the second operation is parallel with the stress sequence of the first operation.

2. The nonvolatile memory device of claim 1, wherein the operation controller comprises:
a preparation state unit configured to sequentially receive the first and second commands, respectively execute preparation sequences of the first and second operations in response to the first and second commands, and activate a preparation state termination signal following execution of each preparation state; and
a stress state unit configured to execute a stress sequence associated with the second operation only in response to activation of a command indication signal indicating the second command is a current command, activation of a preparation state termination signal indicating execution of a preparation sequence for the second command, and a succeeding command OK signal indicating execution of the stress sequence associated with the first operation.

3. The nonvolatile memory device of claim 2, wherein the operation controller further comprises:
a logic unit configured to receive the command indication signal, the preparation state termination signal, and the succeeding command OK signal, and activating a stress operation signal upon concurrent activation of the command indication signal, the preparation state termination signal, and the succeeding command OK signal,
wherein execution of a stress sequence by the stress state unit is enabled by an activated stress operation signal.

4. The nonvolatile memory device of claim 3, wherein the stress state unit is further configured to activate the succeeding command OK signal upon execution of a corresponding stress sequence.

5. The nonvolatile memory device of claim 1, wherein the operation controller controls operation of the memory by providing an address signal and one or more control signals.

6. The nonvolatile memory device of claim 1, further comprising:
a command generation unit generating the first and second command.

7. The nonvolatile memory device of claim 1, wherein the command buffer is a first-in, first-out (FIFO) command buffer.

8. The nonvolatile memory device of claim 1, wherein the first and second operations are respectively an erase operation and a write buffer operation.

9. The nonvolatile memory device of claim 1, wherein execution of the stress sequence for the second operation is delayed by a wait period following execution of the preparation sequence for the second operation until the stress sequence for the first operation is completed.

10. A system comprising:
a memory controller configured to control the operation of a NAND flash memory device, the memory controller comprising:
a command buffer configured to receive and store a sequence of first and second commands; and
an operation controller configured to control the execution of first and second operations in the NAND flash memory device, as respectively defined by the first and second commands, wherein each one of the first and second operations comprises a preparation sequence followed by a stress sequence, and execution of the preparation sequence for the second operation is parallel with the stress sequence of the first operation.
